(19) United States
(12) Patent Application Publication
(10) Pub. No.: US 2015/0291802 A1
(43) Pub. Date: Oct. 15, 2015

(54) BLACKENING COATING AND ELECTRODE STRUCTURE USING THE SAME

(71) Applicant: J TOUCH CORPORATION, Taoyuan County (TW)

(72) Inventors: YU-CHOU YEH, TAOYUAN COUNTY (TW); TSUNG-HER YEH, NEW TAIPEI CITY (TW); SZU-KAI LIAO, TAOYUAN COUNTY (TW); CHIU-CHENG TSUI, TAOYUAN COUNTY (TW)

(73) Assignee: J TOUCH CORPORATION, Taoyuan County (TW)

(21) Appl. No.: 14/253,045

(22) Filed: Apr. 15, 2014

(51) Int. Cl. C09D 5/00; H01B 1/02; C09D 161/06

(52) U.S. Cl. CPC C09D 5/006; C09D 161/06; H01B 1/02; C08K 7/18

(57) ABSTRACT

A blackening coating and an electrode structure using the same are provided. The blackening coating has the effect of anti-corrosion and reducing metallic luster for invisibility, thus the blackening layer formed with the present blackening coating can replace the convention resist layer to simplify the process of the electrodes on touch panel, and to achieve the efficacy of cost down and reducing metallic luster.

### BACKGROUND OF THE INVENTION

1. Field of the Invention

The present disclosure relates to a blackening coating and an electrode structure for touch panel; in particular, to a blackening coating for reducing metallic luster and providing the effect of anti-corrosion and invisibility, and to an electrode structure using the same.

2. Description of Related Art

Conventional touch panel generally use indium tin oxide (ITO) to form the electrodes to make the electrodes imperceptible. Merely, with the gradual development to the large-size touch panel, some defects of ITO electrodes are emerged such as high resistance, slow response, etc. Therefore, the industry has been trying to use thin metal wires to form the electrodes.

However, using metal conductor as the electrodes in touch panel may cause metallic luster and chromatic aberration between the thin metal wires and the screen color, which will lead the metal conductor to be apparently visible for human, thereby affecting the performance of the touch panel display.

Therefore, it is desirable to reduce the metallic luster and the chromatic aberration between the electrode and the screen.

### SUMMARY OF THE INVENTION

The object of the present disclosure is to provide a blackening coating for reducing the metallic luster from the metal electrodes and achieving the effect of anti-corrosion and invisibility.

The present disclosure is to provide a blackening coating comprising a phenolic resin, a photosensitive compound, an organic colored polymer dye, an inorganic colored dye and a solvent, wherein the phenolic resin, the photosensitive compound, the organic colored polymer dye, the inorganic colored dye and the solvent are mixed with each other. Preferably, the weight percent of the phenolic resin is 25%-50%, the weight percent of the photosensitive compound is 1%-5%, the weight percent of the organic colored polymer dye is 1%-20%, the weight percent of the solvent is 50%-75% and the solvent may be methoxypropylacetate.

According to an embodiment of the present disclosure, the blackening coating may further comprise a propoxy ethyl acetate, which is mixed one another with the phenolic resin, the photosensitive compound, the organic colored polymer dye, the inorganic colored dye and the solvent. Preferably, the weight percent of the phenolic resin is 5%-45%, the weight percent of the photosensitive compound is 1%-15%, the weight percent of the organic colored polymer dye is 1%-20%, the weight percent of the solvent is 20%-30%, the weight percent of the propoxy ethyl acetate is 45%-95% and the solvent may be one selected from the group consisting of methoxypropylacetate, propylene glycol monomethyl ether and its mixture.

According to an embodiment of the present disclosure, the phenolic resin, the photosensitive compound, the organic colored polymer dye, and the solvent form a mixture denoted by A, and the mixture A and the inorganic colored dye form the blackening coating, in which the weight percent of the mixture A is 60%-99% and the weight percent of the inorganic colored dye is 1%-40%. The weight percent of the phenolic resin in the mixture A is 25%-50%. The weight percent of the photosensitive compound in the mixture A is 1%-5%. The weight percent of the organic colored polymer dye in the mixture A is 1%-20%. The weight percent of the solvent in the mixture A is 40%-70%, and the solvent may include methoxypropylacetate.

According to an embodiment of the present disclosure, the phenolic resin, the photosensitive compound, the organic colored polymer dye, and the solvent form a mixture denoted by B, and the mixture B and the inorganic colored dye form the blackening coating, in which the weight percent of the mixture B is 60%-99% and the weight percent of the inorganic colored dye is 1%-40%. The weight percent of the phenolic resin in the mixture B is 5%-45%. The weight percent of the photosensitive compound in the mixture B is 1%-15%. The weight percent of the organic colored polymer dye in the mixture B is 1%-20%. The weight percent of the solvent in the mixture B is 45%-90%, and solvent may include one selected from the group consisting of propoxy ethyl acetate, methoxypropylacetate, and proprylene glycol monomethyl ether.

According to an embodiment of the present disclosure, the inorganic colored dye may comprise one selected from the group consisting of spherical inorganic carbon and nano silver ball; the organic colored polymer dye may comprise one selected from the group consisting of poly 3,4-ethylenedioxythiophene and black polyaniline.

Another object of the present disclosure is to provide an electrode structure for a touch panel, the electrode structure comprising a substrate, a conductive layer and the blackening coating as aforesaid present disclosure, wherein the blackening coating is covered on the conductive layer to form a blackening layer.

According to an embodiment of the present disclosure, wherein the material to form the substrate may comprise plastic and glass.

According to an embodiment of the present disclosure, wherein the material to form the conductive layer may comprise one selected from the group consisting of copper, aluminum, nickel, iron, gold, silver, stainless steel, tungsten, chromium, titanium and its alloys.

By the above configuration, the blackening coating of the present disclosure can produce the effect of anti-corrosion, and utilizing the blackening coating of the present disclosure to form a blackening layer on the metal conductor can reduce the metallic luster from the metal electrodes and provide the effect of anti-corrosion and invisibility

In order to further understand the present disclosure, the following embodiments and illustrations are provided. However, the detailed description and drawings are merely illustrative of the disclosure, rather than limiting the scope being defined by the appended claims and equivalents thereof.

### BRIEF DESCRIPTION OF THE DRAWINGS

FIG. 1A-1E are schematic diagrams of the blackening coating forming the blackening layer in accordance with different embodiments of the present disclosure;

FIG. 2 is a flow diagram of the blackening coating forming the blackening layer in accordance with an embodiments of the present disclosure; and

FIG. 3 is a schematic diagram of the blackening coating forming the blackening layer in accordance with an embodiment of the present disclosure.

### DETAILED DESCRIPTION OF THE PREFERRED EMBODIMENTS

A blackening coating and an electrode structure using the same of the present disclosure will be explained below through the embodiments. It has to be mentioned, the embodiments of the present invention are not intended to limit the present invention implementing in any specific environment, applications, or particular manner as described below. Therefore, the description of the embodiments only explains the purpose of the invention, not to limit the present invention.

The blackening coating of the present disclosure comprises a phenolic resin, a photosensitive compound, an organic colored polymer dye, an inorganic colored dye and a solvent, wherein the phenolic resin, the photosensitive compound, the organic colored polymer dye, the inorganic colored dye and the solvent are mixed with each other. Preferably, the weight percent of the phenolic resin is 25%-50%, the weight percent of the photosensitive compound is 1%-5%, the weight percent of the organic colored polymer dye is 1%-20% and the weight percent of the solvent is 50%-75%. In this embodiment, the solvent may be methoxypropylacetate, but not to limit the present invention.

According to another embodiment, the blackening coating of the present disclosure may further comprise a propoxy ethyl acetate, which is mixed one another with the phenolic resin, the photosensitive compound, the organic colored polymer dye, the inorganic colored dye and the solvent, preferably, the weight percent of the phenolic resin is 5%-45%, the weight percent of the photosensitive compound is 1%-15%, the weight percent of the organic colored polymer dye is 1%-20%, the weight percent of the solvent is 20%-30% and the weight percent of the propoxy ethyl acetate is 45%-95%. In this embodiment, the solvent may be one selected from the group consisting of methoxypropylacetate, propylene glycol monomethyl ether and its mixture, but not to limit the present invention.

According to an embodiment of the present disclosure, the phenolic resin, the photosensitive compound, the organic colored polymer dye, and the solvent form a mixture denoted by A, and the mixture A and the inorganic colored dye form the blackening coating, in which the weight percent of the mixture A is 60%-99% and the weight percent of the inorganic colored dye is 1%-40%. The weight percent of the phenolic resin in the mixture A is 25%-50%. The weight percent of the photosensitive compound in the mixture A is 1%-5%. The weight percent of the organic colored polymer dye in the mixture A is 1%-20%. The weight percent of the solvent in the mixture A is 40%-70%, and the solvent may include methoxypropylacetate.

According to an embodiment of the present disclosure, the phenolic resin, the photosensitive compound, the organic colored polymer dye, and the solvent form a mixture denoted by B, and the mixture B and the inorganic colored dye form the blackening coating, in which the weight percent of the mixture B is 60%-99% and the weight percent of the inorganic colored dye is 1%-40%. The weight percent of the phenolic resin in the mixture B is 5%-45%. The weight percent of the photosensitive compound in the mixture B is 1%-15%. The weight percent of the organic colored polymer dye in the mixture B is 1%-20%. The weight percent of the solvent in the mixture B is 45%-90%, and solvent may include one selected from the group consisting of propoxy ethyl acetate, methoxypropylacetate, and proprylene glycol monomethyl ether.

It shall be mentioned, in afore two embodiments, the inorganic colored dye may comprise one selected from the group consisting of spherical inorganic carbon and nano silver ball; the organic colored polymer dye may comprise one selected from the group consisting of poly 3,4-ethylenedioxythiophene and black polyaniline, but not to limit the present invention.

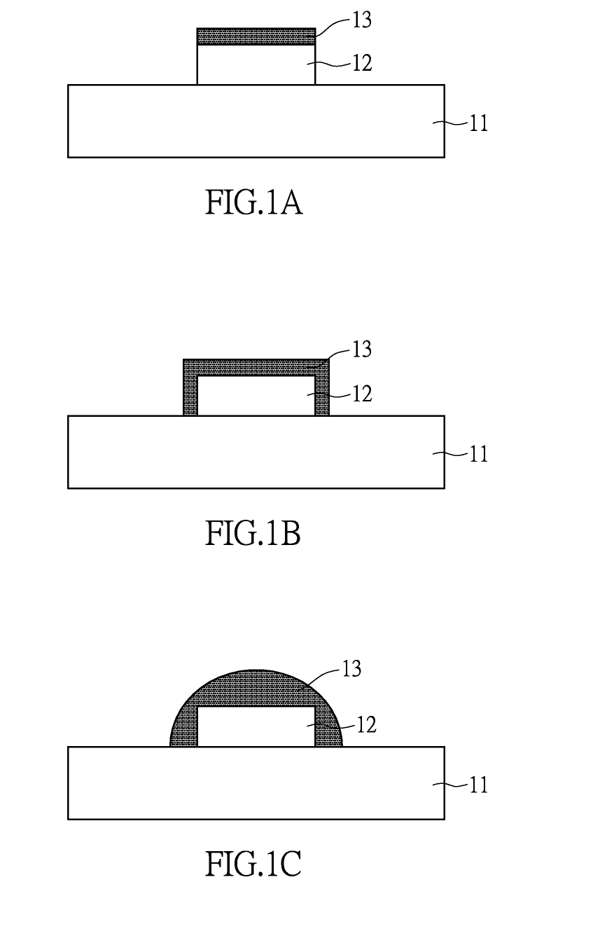

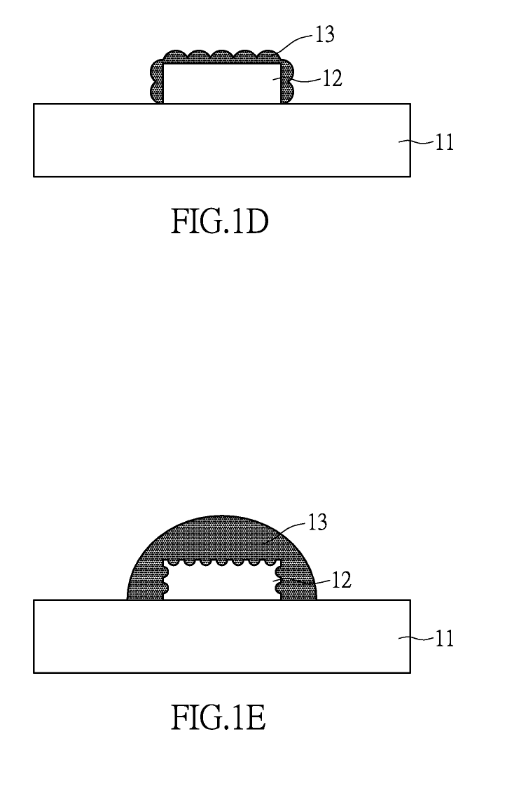

Please refer to FIG. 1A-1E, which are schematic diagrams of the blackening coating forming the blackening layer in accordance with different embodiments of the present disclosure. The blackening coating of the present disclosure can be applied for touch panel to form an electrode structure of the present disclosure. The electrode structure may comprise a substrate 11, a conductive layer 12 and the blackening coating as aforesaid present disclosure, wherein the conductive layer 12 is set on the substrate 11 and the blackening coating is covered on the conductive layer 12 to form a blackening layer 13.

The blackening coating of the present disclosure may form the blackening layer 13 on the conductive layer 12 in various manners as shown in FIG. 1A-1E. In detail, in FIG. 1A, the blackening layer 13 only formed on the surface of the conductive layer 12 to provide the effects of reducing metallic luster and the chromatic aberration between the electrode and the screen, and anti-corrosion in a simple manner. For example, when the screen backlight is turned off, the reflection is lower than 30%, the a/−a axis in chromaticity coordinates is lower than −2 while the b/−b axis is lower than −4. In particular, the chromaticity of the screen with polarizer is much closer to blue-green. In the chromaticity coordinate which consists of three parameters specified as L (lightness), a (red and green) and b (yellow-blue), the characteristic ranges the blackening layer 13 respectively are L<50, a<−0.1, and b<−0.1. Therefore, the blackening layer 13 can adjust the metallic color of the metal wires which is collocated therewith to be close to Black Matrix (BM) of the screen to reduce the chromatic aberration. In FIG. 1B, the blackening layer 13 completely cover on the conductive layer 12 in fixed thickness to provide the entire effect of reducing metallic luster and anti-corrosion. In FIG. 1C, the blackening layer 13 is formed on the conductive layer 12 in the section shape of drops to provide the effect of anti-corrosion and reducing metallic luster in wider visual angle. In FIG. 1D, the blackening layer 13 is formed on the conductive layer 12 in granular surface manner to further reduce metallic luster and provide the effect of anti-corrosion. In FIG. 1E, the blackening layer 13 is formed on the granular surfaced conductive layer 12 to reduce metallic luster in the aspect of the conductive layer 12.

It must be emphasized that the aforesaid embodiments only for illustrating the blackening coating of the present disclosure may be formed on the conductive layer 12 in various manners and is not to limit the present invention. For example, the blackening layer 13 also can be formed on the granular surfaced conductive layer 12 in granular surface manner to further reduce metallic luster. As long as the competitiveness of products can be improved, for example, to simplify the process, to reduce metallic luster, to decrease the chromatic aberration between the electrode and the screen, and to improve corrosion resistance, etc., are among the concept of the present invention. In addition, the thickness of the conductive layer 12 is between 0.001 um-10 um and the thickness of the blackening layer 13 is between 0.05-15 um; the line width of the conductive layer 12 and the blackening layer 13 are between 1 um-30 um preferably.

In an embodiment, the material of the substrate 11 is preferable to adopt a transparent substrate, such as plastic or glass; the material to form the conductive layer 12 comprises one selected from the group consisting of copper, aluminum, nickel, iron, gold, silver, stainless steel, tungsten, chromium, titanium and its alloys, but not to limit the present invention.

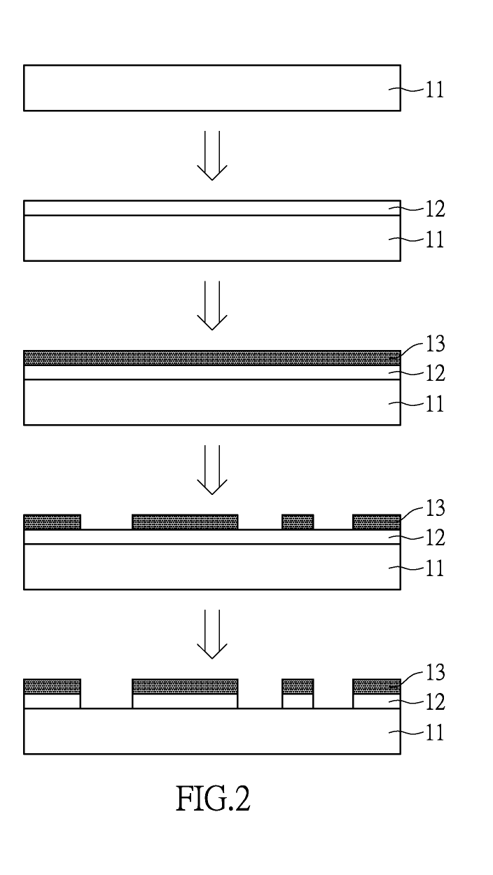

Next, refer to FIG. 2, is a flow diagram of the blackening coating forming the blackening layer in accordance with an embodiments of the present disclosure. The blackening coating of the present disclosure can be used as a resist layer in processes due to the corrosion resistance itself. In an embodiment, the process is as follows: providing a substrate 11; forming a conductor layer 12 on the substrate 11; forming a blackening layer 13 on the conductor layer 12 with the blackening coating of the present disclosure; patterning the blackening layer 13; etching the exposed conductor layer 12. For example, the blackening coating can be coated on the conductive layer 12 by screen printing, scraper, coating-rods, or rotate. The blackening layer 13 patterning method can be e.g. mask lithography etching or laser beam engraving, and it also can take hydrophilic treatment to the surface of the metal wires to make the blackening coating can be selectively self-assemble attached to the surface of the metal wires instead of the hydrophobic surface of the PET, but not be limited the present invention. In this way, the blackening layer can be partially formed only on the metal wires pattern in simple steps.

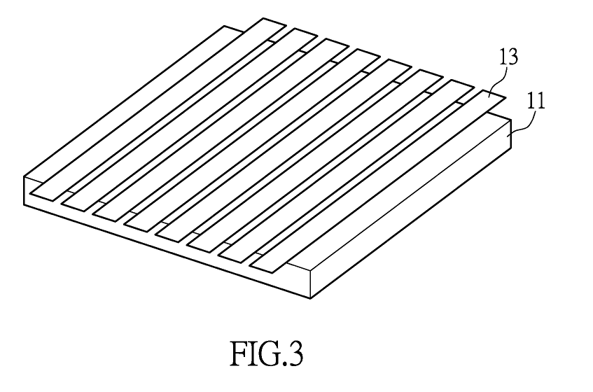

In practice, FIG. 3 is a schematic diagram of the blackening coating forming the blackening layer in accordance with an embodiment of the present disclosure. The figure shows the blackening coating applied to electrode structure of the present invention. The metal electrode wires (i.e. the conductor layer 12) on the substrate 11 are covered with the blackening layer 13, so it is not easy to detect metallic luster with human eyes. The ultra thin electrode wires with the transparent substrate can significantly enhance the performance of the touch panel display. Wherein the electrode wires may be set on the same surface but in different directions to form alternately anode and cathode to sense the position we touch by resistance; the electrode wires can also be alternately set in different surfaces to sense the position we touch by capacitance. As long as the part seen by human eyes can be covered, the sensor type is not in the scope of the present invention. Be emphasized that all the metal electrode wires in figure protruding over the substrate 11 are for illustration only, not for the actual situation.

In summary, the present disclosure provides a blackening coating with the effect of anti-corrosion and an electrode structure using the blackening coating forming a blackening layer on the conductive layer, thus not only to reduce the metallic luster of metal electrodes to enhance the performance of the touch panel display, but also to replace the resist layer in processes with this blackening coating to simplify the manufacturing steps and reduce the cost.

What is claimed is:

1. A blackening coating comprising:
a phenolic resin;
a photosensitive compound;
an organic colored polymer dye;
an inorganic colored dye; and
a solvent,
wherein the phenolic resin, the photosensitive compound, the organic colored polymer dye, the inorganic colored dye and the solvent are mixed with each other.

2. The blackening coating of claim 1, wherein the organic colored polymer dye comprises one selected from the group consisting of poly 3,4-ethylenedioxythiophene and black polyaniline.

3. The blackening coating of claim 1, wherein the inorganic colored dye comprises one selected from the group consisting of spherical inorganic carbon and nano silver ball.

4. The blackening coating of claim 1, wherein the phenolic resin, the photosensitive compound, the organic colored polymer dye, and the solvent form a mixture denoted by A, the weight percent of the phenolic resin in the mixture A is 25%-50%, the weight percent of the photosensitive compound in the mixture A is 1%-5%, the weight percent of the organic colored polymer dye in the mixture A is 1%-20%, the weight percent of the solvent in the mixture A is 40%-70%, and the mixture A and the inorganic colored dye form the blackening coating, in which the weight percent of the mixture A is 60%-99% and the weight percent of the inorganic colored dye is 1%-40%.

5. The blackening coating of claim 4, wherein the solvent comprises methoxypropylacetate.

6. The blackening coating of claim 1, wherein the phenolic resin, the photosensitive compound, the organic colored polymer dye, and the solvent form a mixture denoted by B, the weight percent of the phenolic resin in the mixture B is 5%-45%, the weight percent of the photosensitive compound in the mixture B is 1%-15%, the weight percent of the organic colored polymer dye in the mixture B is 1%-20%, the weight percent of the solvent in the mixture B is 45%-90%, and the mixture B and the inorganic colored dye form the blackening coating, in which the weight percent of the mixture B is 60%-99% and the weight percent of the inorganic colored dye is 1%-40%.

7. The blackening coating of claim 6, wherein the solvent comprises one selected from the group consisting of propoxy ethyl acetate, methoxypropylacetate, and proprylene glycol monomethyl ether.

8. An electrode structure for a touch panel, the electrode structure comprising:
a substrate;
a conductive layer; and
a blackening coating comprising a phenolic resin, a photosensitive compound, an organic colored polymer dye, an inorganic colored dye and a solvent;
wherein the phenolic resin, the photosensitive compound, the organic colored polymer dye, the inorganic colored dye and the solvent are mixed with each other, and the blackening coating is covered on the conductive layer to form a blackening layer.

9. The electrode structure of claim 8, wherein the organic colored polymer dye comprises one selected from the group consisting of poly 3,4-ethylenedioxythiophene and black polyaniline.

10. The electrode structure of claim 8, wherein the inorganic colored dye comprises one selected from the group consisting of spherical inorganic carbon and nano silver ball.

11. The electrode structure of claim 8, wherein the material to form the substrate comprises plastic and glass.

12. The electrode structure of claim 8, wherein the material to form the conductive layer comprises one selected from the group consisting of copper, aluminum, nickel, iron, gold, silver, stainless steel, tungsten, chromium, titanium and its alloys.

13. The electrode structure of claim 8, wherein the thickness of the conductive layer is between 0.001 um and 10 um, the width of the conductive layer is between 1 um and 30 um, the thickness of the blackening layer is between 0.05 um and 15 um and the width of the blackening layer is between 1 um and 30 um.

14. The electrode structure of claim 8, wherein the phenolic resin, the photosensitive compound, the organic colored polymer dye, and the solvent form a mixture denoted by A, the weight percent of the phenolic resin in the mixture A is 25%-50%, the weight percent of the photosensitive compound in the mixture A is 1%-5%, the weight percent of the organic colored polymer dye in the mixture A is 1%-20%, the weight percent of the solvent in the mixture A is 40%-70%, and the mixture A and the inorganic colored dye form the blackening coating, in which the weight percent of the mixture A is 60%-99% and the weight percent of the inorganic colored dye is 1%-40%.

15. The blackening coating of claim 14, wherein the solvent comprises methoxypropylacetate.

16. The blackening coating of claim 8, wherein the phenolic resin, the photosensitive compound, the organic colored polymer dye, and the solvent form a mixture denoted by B, the weight percent of the phenolic resin in the mixture B is 5%-45%, the weight percent of the photosensitive compound in the mixture B is 1%-15%, the weight percent of the organic colored polymer dye in the mixture B is 1%-20%, the weight percent of the solvent in the mixture B is 45%-90%, and the mixture B and the inorganic colored dye form the blackening coating, in which the weight percent of the mixture B is 60%-99% and the weight percent of the inorganic colored dye is 1%-40%.

17. The blackening coating of claim 16, wherein the solvent comprises one selected from the group consisting of propoxy ethyl acetate, methoxypropylacetate, and proprylene glycol monomethyl ether.
